(19) United States
(12) Patent Application Publication
(10) Pub. No.: US 2002/0175791 A1
(43) Pub. Date: Nov. 28, 2002

(54) Solenoid for actuating valves

(75) Inventors: Drew LaMarca, Whippany, NJ (US); King W. Lee, Raritan, NJ (US); John J. Haller, Boonton, NJ (US); Emmanuel D. Arceo, Bloomfield, NJ (US)

Correspondence Address: HOWREY SIMON ARNOLD & WHITE, 750 Bering Drive, Houston, TX, 77057-2198, US

(73) Assignee: ASCO CONTROLS, L.P.

(21) Appl. No.: 10/126,444

(22) Filed: Apr. 19, 2002

Related U.S. Application Data
(60) Provisional application No. 60/284,821, filed on Apr. 19, 2001.

(51) Int. Cl. H01F 7/08

(52) U.S. Cl. 335/220

(57) ABSTRACT

An improved solenoid is provided that has a fully enclosing yoke with integral end cap and sleeve. A second, separate, or alternatively integral end cap with sleeve is provided to complete the magnetic yoke. The yoke/coil assembly is encapsulated with a liquid crystal polymer that has a melting temperature higher than the melting temperature of the coil bobbin to provide a good bond therebetween.

### CROSS REFERENCE TO RELATED APPLICATIONS

This application claims the benefit of the Provisional Application No. 60/284,821 filed Apr. 19, 2001.

### BACKGROUND OF THE INVENTION

1. Field of the Invention

This invention relates generally to electromagnetic solenoids for actuating valves and other flow control devices and more specifically to an improved solenoid structure, solenoid control and method of manufacture.

2. Description of the Related Art

Solenoids are generally described as an electromagnet having a typically cylindrical, energizable coil and an armature located within and along the axis of the coil. Structurally, most solenoids have been constructed by spirally winding an electrical conductor around a non-magnetic bobbin or spool. A magnetic yoke or shell partially or completely surrounds the coil to define a magnetic circuit and protect the coil. Separate end caps with sleeves are typically used with the yoke to help shape the magnetic field. A non-conductive encapsulation, such as plastic, epoxy or the like, typically surrounds the yoke and coil, while allowing the coil leads to project through and the armature to reciprocate with the coil.

When electrical current is applied to the coil, a magnetic flux path is established by the properties of the coil, end caps and yoke causing the armature to move along the coil axis. The armature force generated by the energized solenoid is dependent upon the properties and structure of the coil, end caps and yoke and the amount and nature of current applied to the coil.

Historically, the design and manufacture of solenoids has attempted to address a variety of concerns, such as: durability; reliability competitive pricing; ease of manufacture (e.g., minimum number of parts); and compliance with a variety of governmental standards. Typically, a solenoid manufacturer has had to offer approximately 400 different solenoid models to meet the needs of the market.

U.S. Pat. No. 4,679,767, assigned to Automatic Switch Company, is an example of a solenoid in which the coil is completely encapsulated by a thermosetting resin and the yoke is encapsulated by a thermoplastic resin in an effort to impart durability and reliability to the solenoid.

Similarly, U.S. Pat. No. 4,683,454, also assigned to Automatic Switch Company, is an example of a solenoid in which a variety of electrical connector modules are attached to the solenoid coil leads. The body of each module is formed of a resilient material so that when the module is tightly attached to the coil encapsulation, a seal is formed completely surrounding the coil terminals.

### SUMMARY OF THE INVENTION

One aspect of the present invention provides a solenoid actuator, which includes a non-magnetic bobbin, a coil, a yoke and a shell. The non-magnetic bobbin has first and second flanges, an outer cylindrical wall disposed between the flanges and a central opening defined by an inner cylindrical wall disposed between the flanges. The coil of electrically conductive wire is spirally wound about the outer cylindrical wall of the bobbin. The yoke of magnetically conductive material includes a body and a first end cap. The body fully encases an outer cylindrical surface of the coil. The first end cap is integrally connected with the body and has a sleeve extending into an end of the central opening of the bobbin. A second end cap of magnetically conductive material is attached to the body and has a sleeve extending into another end of the central opening of the bobbin. The shell encapsulates the yoke and bobbin to produce a hermetically sealed solenoid.

Another aspect of the present invention provides a solenoid actuator, including a yoke, solenoid coil, a first end cap, a second end cap and a shell. The yoke is composed of magnetically conductive material having first and second ends. The electromagnetic solenoid coil is disposed in the yoke and has a bobbin with a coil of electrically conductive wire spirally wound thereabout. The first end cap of magnetically conductive material is attached to the first end of the yoke. The second end cap of magnetically conductive material is attached to second end of the yoke. The shell is composed of a first liquid crystal polymer encapsulating the yoke and the solenoid coil and forming a bond with the bobbin by an injection molding process.

Yet another aspect of the present invention provides a method of manufacturing a solenoid. The method includes forming a substantially planar body from a sheet of magnetically hard or soft material; forming a first end cap integrally connected with the planar body; forming a first integral sleeve through a central opening defined in the first end cap; forming a second end cap having a second integral sleeve; shaping the substantially planar body into a substantially cylindrical yoke; and bending the first end cap to cover an adjacent opening in the cylindrical yoke so that the first integral sleeve resides within the cylindrical yoke. The method also includes placing an electromagnetic solenoid coil within the cylindrical yoke so that the first integral sleeve on the first end cap extends into a bore in the coil; covering a remaining opening of the cylindrical yoke with the second end cap so that the second integral sleeve extends into the bore in the coil; and encapsulating the yoke/coil assembly with a protective coating.

One aspect of the present invention provides a control circuit for operating a solenoid. The control circuit includes a voltage rectifying circuit, a power supply circuit and a logic circuit. The voltage rectifying circuit is adapted to rectify voltages selected from the group consisting of: about 100 to 240 VAC; about 100 to 240 VDC; about 24 to 100 VAC; about 24 to 100 VDC; and about 12 to 24 VDC. The power supply circuit is coupled to the voltage rectifying circuit. The power supply circuit is adapted to provide an Inrush current and a Holding current to the solenoid. The Holding current is less than and proportional to the Inrush current. The logic circuit is adapted to control application of the Inrush current for a beginning portion of each on/off cycle time of about 50 to 65 milliseconds. The logic circuit is adapted to control application of the Holding current for a remaining portion of each on/off cycle time.

The foregoing summary is not intended to summarize each potential embodiment or every aspect of the invention disclosed herein, but merely to summarize the appended claims.

### BRIEF DESCRIPTION OF THE DRAWINGS

The following figures illustrate, in conjunction with the written description, preferred and other embodiments of the present invention.

FIG. 1 is an illustration of a solenoid according to the invention.

FIG. 2 is an illustration of a bobbin for use with the present invention.

FIG. 3 is a cross-sectional drawing of a coil for use with the present invention.

FIGS. 4, 5 and 6 are illustrations of a magnetic yoke for use with the present invention comprising a body, an integral end cap with sleeve and a separate end cap with sleeve.

FIG. 7 is an illustration of a magnetic yoke for use with the present invention comprising a body with two integral end caps with sleeves.

FIG. 8 is an exploded illustration showing a yoke with separate end cap and coil of the present invention.

FIG. 9 is a graph illustrating the current supply characteristics of a preferred control circuit according to the present invention.

FIGS. 10a10c are schematic representations of control circuits for use with the present invention.

FIG. 11 illustrates a solenoid according to the present invention.

These figures and written description are not intended to limit the breadth or scope of the invention in any manner, rather they are provided to illustrate the invention to a person of ordinary skill in the art by reference to a particular embodiment of the invention, as required by 35 USC §112.

### DETAILED DESCRIPTION OF THE INVENTION

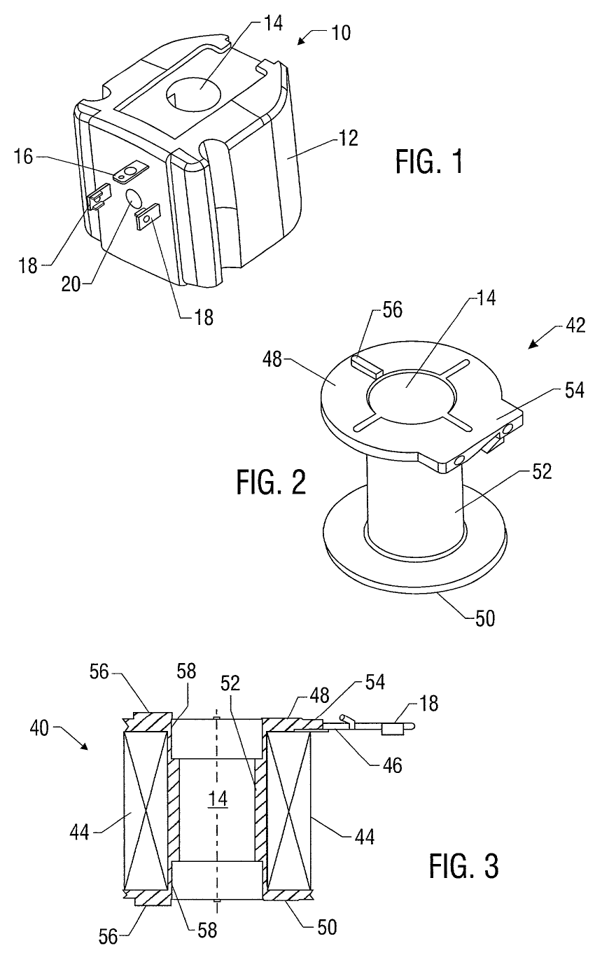

FIG. 1 illustrates a preferred, but not exclusive embodiment of the improved solenoid 10 of the present invention. The improved solenoid 10 shown in FIG. 1 has an outer encapsulation 12 that protects the internal components of the solenoid 10 and which provides a hermetic seal for the solenoid. The central opening 14 of the solenoid 10 is shown while the armature that resides in the central opening is not shown. A grounding lead 16 and coil leads 18 are also shown emanating from the encapsulation 12. Also shown is a threaded connection 20.

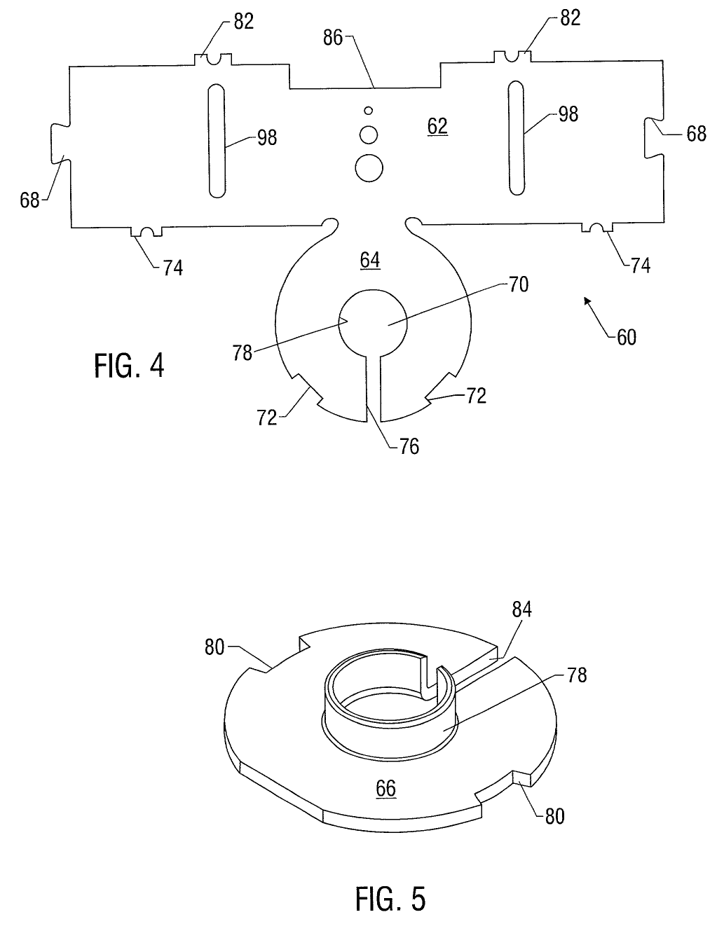

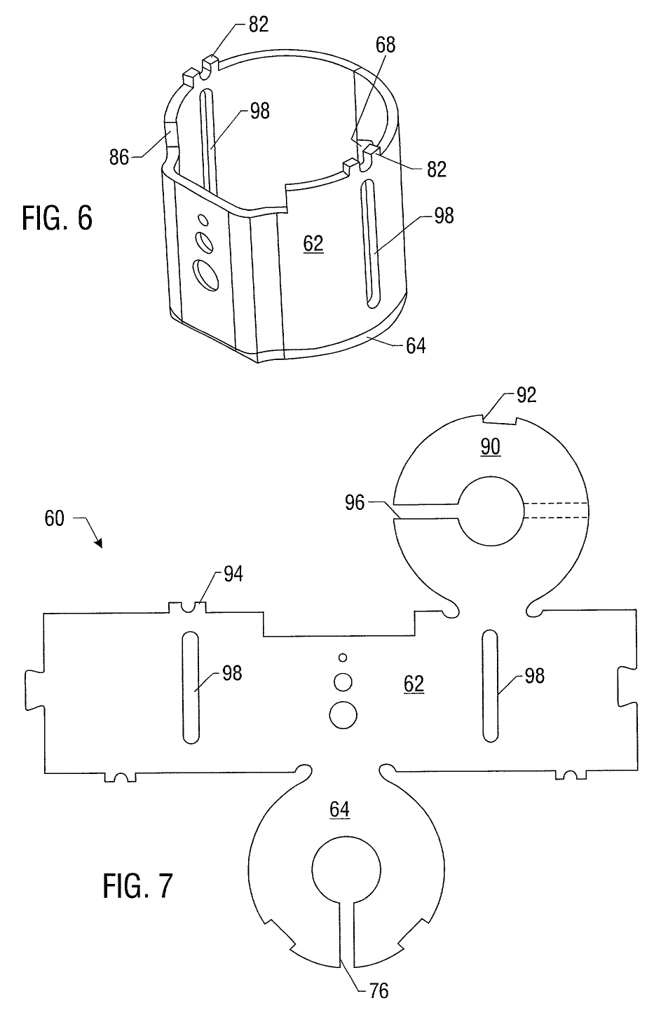

FIGS. 2 and 3 show the new and improved coil 40 of the present invention in more detail. The coil 40 comprises a bobbin 42, an electrical conductor 44 spirally wound about the bobbin 42 and a pair of terminal contacts 46.

Referring specifically to FIG. 2, the bobbin 42 of the present invention is preferably fabricated from Dupont's Zenite liquid crystal polymer, grade 2130, in an injection molding operation. The bobbin 42 comprises an upper flange 48 and a lower flange 50, which are separated and joined by a tubular portion 52. The inner surface of tubular portion 52 defines a portion of the central opening 14 of the solenoid 10. The upper flange 48 of bobbin 42 has a termination portion 54 to which terminal contacts 46 are joined. The bobbin 42 of the present invention may also have on its upper flange 48 or its lower flange 50 one or more alignment tabs 56 for correctly orienting the coil 40 within the solenoid 10. In FIG. 2, the alignment tab 56 is shown to be on the upper flange 48 opposite the terminal portion 54.

Referring now to FIG. 3, the electrical conductor 44 is preferably a continuous wire. The electrical conductor 44 is spirally wound around the tubular portion 52 of the bobbin 42 between the upper flange 48 and the lower flange 50. The nature and characteristics of the electrical conductor 44 and the number of spiral wraps of the electrical conductor 44 are design choices left to those skilled in the art of solenoid design.

In this embodiment of the coil 40, the outer spiral wraps of electrical conductor 44 are substantially in plane with the outer edges of the upper flange 48 and the lower flange 50 of the bobbin 42 as shown in FIG. 3. The bobbin 42 also has recesses 58 formed in the tubular portion 52 adjacent the upper and lower flanges 48 and 50. As will be explained in more detail below, these recesses 58 accept the sleeve portions of the yoke end caps.

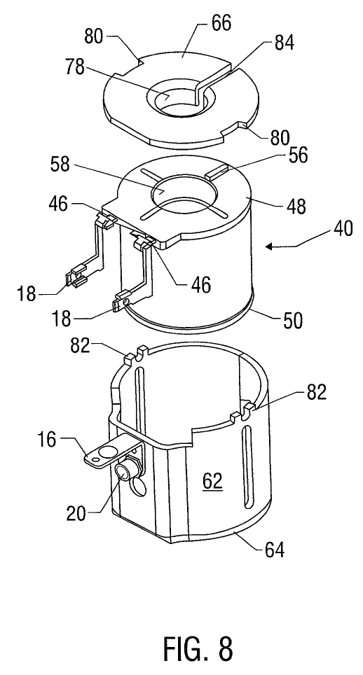

Turning now to FIGS. 4, 5 and 6, there is shown a preferred, but not exclusive embodiment of yoke 60 for the present invention. In this embodiment, the yoke 60 comprises a body 62, an integral end cap with sleeve 64 and a separate end cap with sleeve 66. The yoke 60 is preferably fabricated from type 304 stainless steel that has been heat treated by a stress relieving/annealing process. Alternatively, the yoke 60 can be fabricated from ASTM type A620 cold rolled steel that has been zinc plated. In this embodiment of the present invention, the thickness of the yoke material is preferably 1.9 millimeters (0.0747 inches) thick, except for the sleeves 78 which have been extruded to a thickness of about 0.9 millimeters (0.040 inches). As shown in FIGS. 4 and 6, the yoke 60 is constructed such that the body 62 can be formed into a cylindrical or quasi-cylindrical structure to fully encase the coil 40. The body 62 is shown to have a dove tail 68 that is used to secure the two ends of the body 62 when formed into the quasi-cylindrical shape shown in FIG. 6.

Also shown in FIG. 4 is the integral end cap with sleeve 64, which includes a central opening 70. The central opening 70 of the end cap 64 is designed to align with the central opening 14 of the coil 40. The integral end cap 64 also has grooves 72 that mate with tabs 74 on body 62 when the yoke 60 is formed into its quasi-cylindrical condition. The tabs 74 can be staked against the grooves 72 to hold the integral end cap 64 in tight arrangement with the body 62. Alignment slot 76 in end cap 64 maybe used to orient coil 40 by interfacing with the alignment tab 56. Although not shown in FIG. 4, both integral end cap 64 and separate end cap 66 have an integral sleeve 78, which is shown in FIG. 5. Each sleeve 78 interfaces with the recess 58 of bobbin 42 to preferentially shape the magnetic field of the energized solenoid. The separate end cap 66 shown in FIG. 5 is substantially similar to the integral end cap 64 and includes grooves 80 that mate with tabs 82 on body 62. The separate end cap 66 may also include an alignment slot 84.

Referring back to FIG. 4, the yoke 60 also includes a coil window 86 formed in the body 62. The coil window 86 allows the terminal contacts 46 and coil leads 18 of the coil 40 to emanate from the protection of the yoke 60 without contacting the yoke body 62 or either of the end caps 64 or 66.

As shown in FIG. 6, the body portion 62 with integral end cap 64 can be formed into a quasi-cylindrical shape in which the integral end cap is bent to cover one end of the quasi-cylinder with the end cap sleeve 78 residing within the interior of the cylinder. Separate end cap 66 can be placed on the formed yoke and staked in place to form a structurally sound, fully enclosed magnetic yoke 60.

It will now be appreciated by those skilled in the art having benefit of this disclosure that the yoke 60 of the present invention promotes ease of manufacture because it can be formed or stamped from single sheets of metal and yet provides the most desirable magnetic characteristics. For example, the fully closed body 62 of yoke 60 completely encases the coil 40 which provides superior magnetic flux characteristics compared to prior art C-shaped, or open yokes. Further, the integral end cap with sleeve 64 and separate end cap with sleeve 66 eliminates the prior art requirement of a separate end cap with sleeve, thereby reducing the number of parts and minimizing air gap losses between the yoke and the coil, which gaps are detrimental to magnetic performance of the solenoid 10. Further, the yoke 60 of the present invention allows the solenoid designer to choose any alignment of existing air gaps, such as alignment slots 76 and 84, to maximize or fine tune the magnetic properties of the yoke.

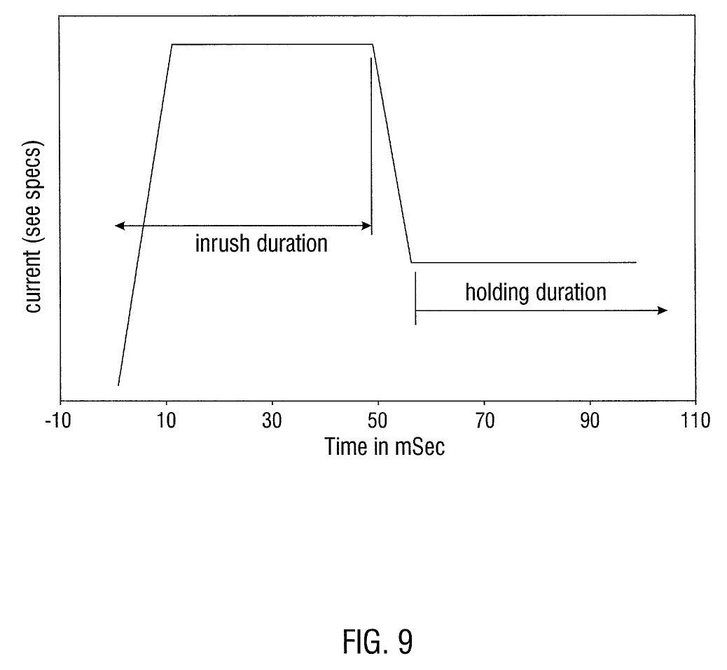

Turning now to FIG. 7, an another embodiment of the present invention is shown in which both end caps are formed integrally with the body 62 of yoke 60. A second integral end cap 90 is shown emanating from the body 62 opposite the side from which the first integral end cap 64 is formed. In this embodiment, the second integral end cap 90 has a groove 92 which mates with a tab 94 on body 62 for holding the second integral end cap 90 tightly in place. The second integral end cap 90 is also shown to have an alignment slot 96, which when the yoke is formed in the quasi-cylindrical shape will be opposite in direction to the alignment slot 76 of first integral end cap 64. Alternatively, the dashed lines indicate that the slot could be on the other side so that it would be in the same direction with the alignment slot 76 of first integral end cap 64. As stated above, the existence and alignment of such air gaps is left to the designer's consideration in order to maximize or fine tune the magnetic properties of the particular solenoid at issue.

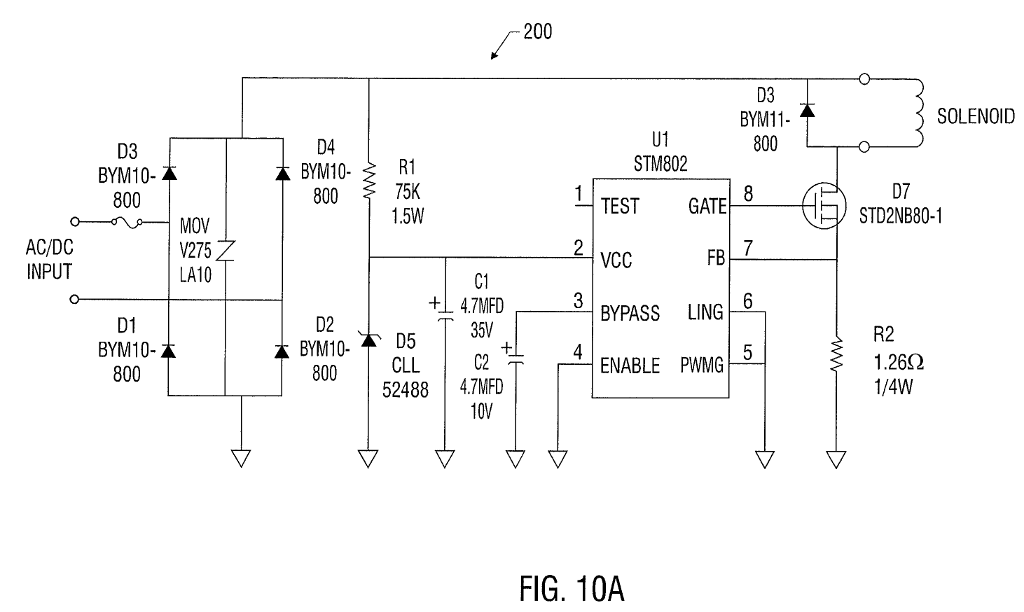

FIG. 8 is an exploded view of the internal components of solenoid 10 formed by the quasi-cylindrical yoke body 62 with integral end cap 64 staked into position. During manufacture of the solenoid 10, the body 62 can be automatically formed into the quasi-cylindrical shape and the integral end cap with sleeve 64 can be bent into position and staked. The coil 40 can be lowered vertically into the interior of the yoke 60 so that sleeve 78 on end cap 64 mates with recess 58 and any alignment tabs, such as alignment tab 56, can mate with any alignment slot, such as alignment slot 76, in end cap 64. In the embodiment that uses a separate end cap 66, the cap is placed on top of coil 40 so that its sleeve 78 interfaces with recess 58 to form the central opening 14 of substantially constant internal dimension. Tabs 82 are staked to securely fasten the separate end cap 66 to the body 62. As shown in FIG. 8 are coil leads 18, which are conductively attached to terminal contacts 46 on coil 40. Solenoid connections 18 can take any of several known formats, such as, for example, pin, DIN or spade. FIG. 8 shows a common DIN connection having two blade coil leads 18 and one blade grounding lead 16. Although the embodiments chosen to illustrate the present invention utilize dove tails and groove tabs to form the yoke, those having benefit of this disclosure, will appreciate that other methods of forming the yoke may be used, such as, for example, welding or brazing.

Once the coil 40 has been loaded into the formed yoke 60 the assembly can be encapsulated to seal and protect the solenoid. In the present invention, it is preferred that the encapsulation 12 is another DuPont liquid crystal polymer, which has a melting point higher than the melting point of the bobbin 42. This melting point differential allows a bond to develop between the encapsulation 12 and the bobbin 42.

During the preferred injection molding encapsulation process, the encapsulation 12 material cools as it is forced into contact with the yoke 60 and coil 40. Applicants have found that if the bobbin 42 has the same or similar melting point as the encapsulation 12, a good adhesion bond will not always be formed between the encapsulation 12 and the coil 40. Applicants have found that by having the bobbin 42 constructed from a material with a melting point lower than the melting point of the encapsulation 12, the exposed portions of the bobbin 42 will form a good bond with the encapsulation 12. In applicant's experience, a melting point differential of approximately 10 degrees Fahrenheit may be sufficient. Referring back to FIGS. 4, 6 and 7, openings 98 may be provided to allow the encapsulation 12 to more easily fill the space between the coil 40 and the yoke 60.

As stated previously, solenoid manufacturers have had to offer approximately 400 different solenoid models to meet the market demand. This large number of models has been caused by the need for AC solenoids covering an operating range of about 24 VAC to about 240 VAC, and DC solenoids covering an operating range of about 12 VDC to about 240 VDC. The present invention reduces the number of solenoid models needed to cover these operating ranges to 3 through an improved control circuit based upon an application specific integrated circuit (ASIC). The present invention provides a first solenoid model as described previously that can operate on about 85 VDC/VAC to about 264 VDC/VAC at approximately 50 or 60 hertz. The present invention provides a second solenoid model as described previously that can operate on about 20 VDC/VAC to about 109 VDC/VAC at approximately 50 to 60 hertz. The present invention also provides a third solenoid model that can operate on about 10 VDC to about 26 VDC. Thus, the present invention provides three basic models of an improved solenoid that span the range of solenoids typically demanded by the market.

The control circuits for these three models are each described as basically a switch mode current regulator with two fundamental modes: Inrush and Holding. The Inrush mode occurs in the first 50-65 milliseconds, preferably 64 milliseconds, of each on/off cycle and the control circuit provides an energizing current, Iᵢₙᵣᵤₛₕ, to activate the solenoid 10. The rise time of Iᵢₙᵣᵤₛₕ is dependent on the coil's resistance and inductance. After the Inrush time period expires, the Holding mode begins. The control circuit provides a holding current, I_{hold}, which is less than and proportional to the Iᵢₙᵣᵤₛₕ current and is fixed by the ratio between Inrush reference voltage V1 and Hold reference voltage V2. The control circuit is basically a constant power control in which approximately 20 watts is supplied during the Inrush mode and approximately 1.2 watts is supplied during the Holding mode. Applicants have found that the use of the Inrush and Holding modes of the preferred embodiment allows the solenoids of the present invention to achieve a full 5 mm of actuator stroke with lower overall power consumption as compared to prior solenoids of similar stroke.

The control circuit also includes a power rectifying circuit for converting all incoming power sources to direct current. By using direct current to drive the solenoid, any hum or noise associated with alternating current is substantially reduced if not eliminated. Further, the rectifying circuit reduces the control circuit's and, therefore, the solenoid's 10 susceptibility to frequency variations. Additionally, the control circuit of the present invention allows the solenoid 10 to operate over the wide voltage ranges described above and on either AC or DC voltages.

The control circuit includes a common clock and a logic circuit. The logic circuit establishes the sequence and timing of the Inrush and Holding modes. In addition, a control pin is provided for allowing the solenoid 10 to be controlled by a bus signal rather than by mere application of power. In the bus control mode, the control pin enables and disables the gate control output for the external power MOS. The MOS transistor is preferably chosen according to the supply voltage range and the current flowing through the solenoid. The control pin functions to activate or deactivate the solenoid. When the control line is grounded, the solenoid is controlled by the application of power to the control circuit as is conventional. When the control pin is not grounded, power is continuously supplied to the control circuit and a bus system operates the solenoid through control pin.

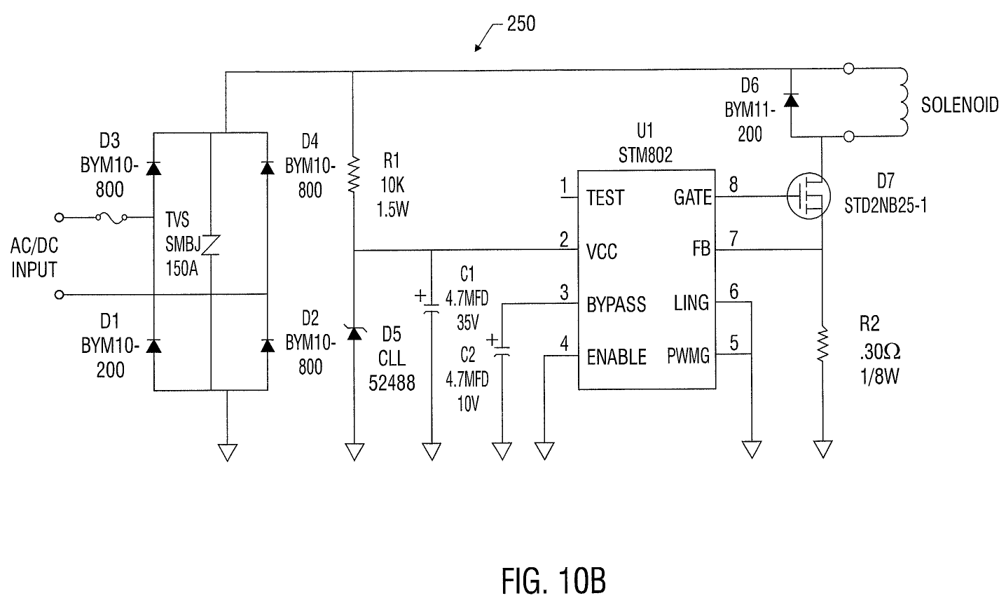

In use, the control circuit limits the average current supplied to the coil 40 to Iᵢₙᵣᵤₛₕ. The control circuit holds the current to the Iᵢₙᵣᵤₛₕ value for approximately the first 50-65 milliseconds after power is applied to the solenoid 10. After the first 50-65 milliseconds of Iᵢₙᵣᵤₛₕ current has been applied, the control circuit reduces the average coil current to a value called I_{hold}. In the preferred embodiment of the control circuit 200, I_{hold} is approximately 25% of the Iᵢₙᵣᵤₛₕ value. When power is disconnected from the control circuit, or when a deactivate signal is applied to the control pin, the solenoid 10 is deactivated. FIG. 9 illustrates the Iᵢₙᵣᵤₛₕ and I_{holding} profile of the control circuits of the present inventions. The holding power supplied by the control circuit is limited to approximately 1.2 watts. Since temperature is a function of power, the more power applied to the control circuit and the solenoid, the greater the temperature increase. Surface temperature is becoming of increasing concern in various markets around the world. For example, the European Low Voltage Directive (EN61010) requires that the surface temperature of a solenoid cannot exceed 80° C. in a 60° C. ambient temperature. As shown in FIG. 9, the total area under the curve is the total power during one cycle. Since the present invention uses a fixed Iᵢₙᵣᵤₛₕ time, the duration of the I_{hold} current is dependent on the cycle time. This means that the higher the cycle time the greater the ratio between Iᵢₙᵣᵤₛₕ and I_{hold} (in other words, the power attributed to I_{hold} increases with increasing cycle time. Therefore, the total power applied to the solenoid increases, which also increases the surface temperature. The present invention allows the first and second models to have as many as 60 cycles per minute without exceeding the 80° C. surface temperature limitation. The present invention also allows the third model to have as many as 20 cycles per minute without exceeding the 80° C. surface temperature requirement.

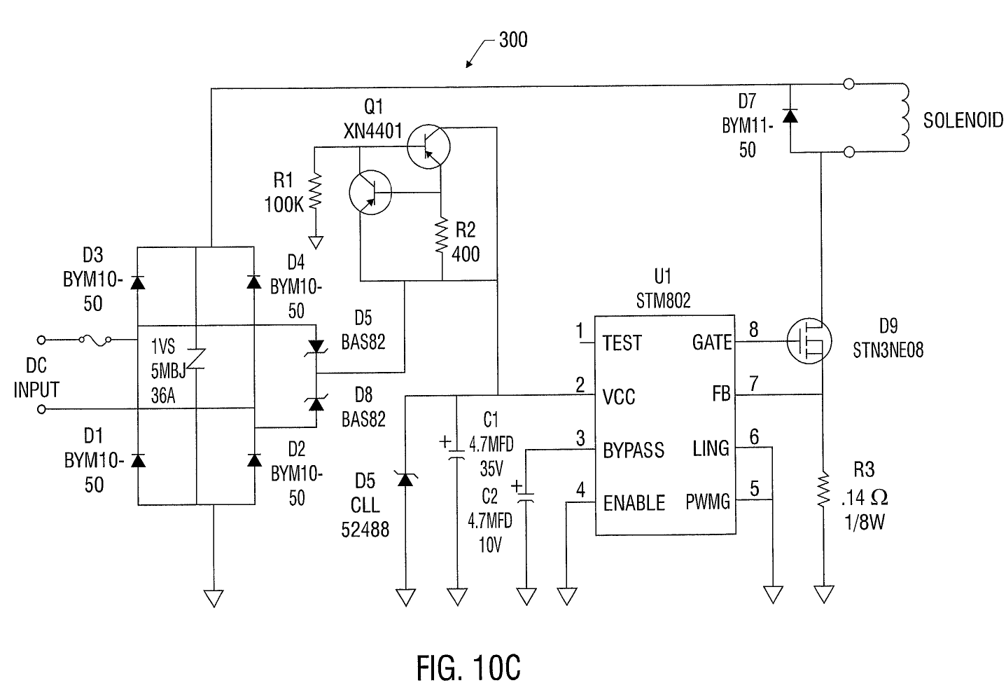

FIG. 10a shows the preferred control circuit 200 for the first solenoid model described above and is capable of handling an input voltage of between about 100-240 VDC/VAC, inclusive. FIG. 10b shows the preferred control circuit 250 for the second solenoid model described above and is capable of handling an input voltage of between about 24-99 VDC/VAC, inclusive. FIG. 10c shows the preferred control circuit 300 for the third solenoid model described above and is capable of handling an input voltage of between about 12-23 VDC.

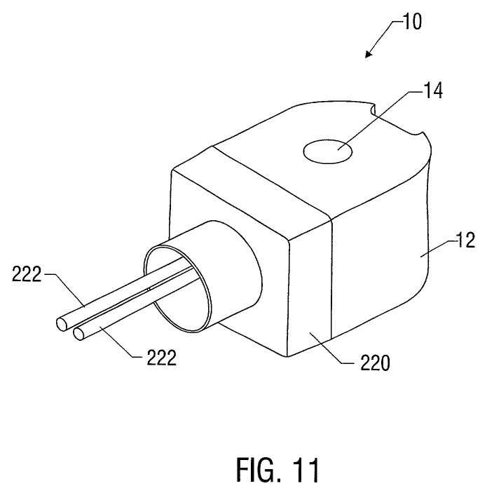

According to the present invention, one of control circuits 200, 250 or 300 is connected to coil leads 18 and grounding lead 16, to a power supply (not shown) and optionally to a control bus (not shown.) The control circuit can be encapsulated along with the solenoid 10 by encapsulation 12 or as, shown in FIG. 11, the control circuit can be housed within a protective cover 220 that is securely attached to solenoid 10. FIG. 11 also shows power supply lead 222.

The foregoing description of preferred and other embodiments of the present invention is not intended to limit or restrict the breadth, scope or applicability of the invention that was conceived of by the Applicants. In exchange for disclosing the inventive concepts contained herein, Applicants desire all patent rights afforded by the appended claims.

What is claimed is:

1. A solenoid actuator comprising:
a non-magnetic bobbin having first and second flanges, an outer cylindrical wall disposed between the flanges and a central opening defined by an inner cylindrical wall disposed between the flanges;
a coil of electrically conductive wire spirally wound about the outer cylindrical wall of the bobbin;
a yoke of magnetically conductive material comprising: a body fully encasing an outer cylindrical surface of the coil, and a first end cap integrally connected with the body and having a sleeve extending into an end of the central opening of the bobbin;
a second end cap of magnetically conductive material attached to the body and having a sleeve extending into another end of the central opening of the bobbin; and
a shell encapsulating the yoke and bobbin to produce a hermetically sealed solenoid.

2. The solenoid actuator of claim 1, wherein the body of the yoke is formed from a substantially planar sheet of magnetically conductive material bent to from a substantially cylindrical body.

3. The solenoid actuator of claim 2, wherein the first end cap integrally connected with the body is bent to cover an adjacent opening of the substantially cylindrical body.

4. The solenoid actuator of claim 1, wherein the second end cap is integrally connected with the body.

5. The solenoid actuator of claim 1, wherein the central opening of the bobbin comprises first and second recesses defined therein to receive the first and second sleeves respectively.

6. The solenoid actuator of claim 1, wherein the shell comprises a first liquid crystal polymer forming a bond with the bobbin and the yoke by an injection molding process.

7. The solenoid actuator of claim 6, wherein the bobbin comprises a second liquid crystal polymer.

8. The solenoid actuator of claim 7, wherein the first liquid crystal polymer of the shell has a first melting point that is higher than a second melting point of the second liquid crystal polymer of the bobbin.

9. The solenoid actuator of claim 8, wherein the first melting point of the shell is approximately 10 degrees Fahrenheit higher than the second melting point of the bobbin.

10. A solenoid actuator, comprising:
a yoke of magnetically conductive material having first and second ends;
an electromagnetic solenoid coil disposed in the yoke and having a bobbin with electrically conductive wire spirally wound thereabout;
a first end cap of magnetically conductive material attached to the first end of the yoke;
a second end cap of magnetically conductive material attached to the second end of the yoke; and
a shell composed of a first liquid crystal polymer encapsulating the yoke and the solenoid coil and bonding with the bobbin composed of a second liquid crystal polymer.

11. The solenoid actuator of claim 10, wherein at least one of the first or second end caps is integrally connected to the yoke.

12. The solenoid actuator of claim 11, wherein the first and second end caps each comprise a sleeve disposed in an end of a central bore of the bobbin.

13. The solenoid actuator of claim 10, wherein the first liquid crystal polymer of the shell has a first melting point that is higher than a second melting point of the second liquid crystal polymer of the bobbin.

14. The solenoid actuator of claim 13, wherein the first melting point of the shell is approximately 10 degrees Fahrenheit higher than the second melting point of the bobbin.

15. A method of manufacturing a solenoid comprising:
forming a substantially planar body from a sheet of magnetically hard or soft material;
forming a first end cap integrally connected with the planar body;
forming a first integral sleeve through a central opening defined in the first end cap;
forming a second end cap having a second integral sleeve;
shaping the substantially planar body into a substantially cylindrical yoke;
bending the first end cap to cover an adjacent opening in the cylindrical yoke so that the first integral sleeve resides within the cylindrical yoke;
placing an electromagnetic solenoid coil within the cylindrical yoke so that the first integral sleeve on the first end cap extends into a bore in the coil;
covering a remaining opening of the cylindrical yoke with the second end cap so that the second integral sleeve extends into the bore in the coil; and
encapsulating the yoke/coil assembly with a protective coating.

16. The method of claim 15, wherein forming the second end cap comprises forming the second end cap integrally connected with the planar body.

17. The method of claim 15, wherein encapsulating the yoke/coil assembly with the protective coating comprises injection molding a first liquid crystal polymer to encapsulate the yoke/coil assembly.

18. The method of claim 17, wherein injection molding the first liquid crystal polymer to encapsulate the yoke/coil assembly comprises bonding the first liquid crystal polymer of the protective coating with a bobbin of the solenoid coil composed of a second liquid crystal polymer.

19. The method of claim 18, wherein bonding the first liquid crystal polymer of the protective coating with the second liquid crystal polymer of the bobbin comprises providing the first liquid crystal polymer with a first melting point that is higher than a second melting point of the second liquid crystal polymer.

20. The method of claim 19, wherein providing the first melting point that is higher than the second melting point comprises providing the first liquid crystal polymer with the first melting point that is approximately 10 degrees Fahrenheit higher than the second melting point of the second liquid crystal polymer.

21. A solenoid control circuit comprising:
a voltage rectifying circuit adapted to rectify voltages selected from the group consisting of: about 100 to 240 VAC; about 100 to 240 VDC; about 24 to 100 VAC; about 24 to 100 VDC; and about 12 to 24 VDC;
a power supply circuit coupled to the voltage rectifying circuit and adapted to provide an approximately 20 watt inrush current for about 50 to 65 milliseconds and a substantially constant approximately 1.2 watt holding current that is about 25% of the inrush current for a predetermined on/off cycle time; and
a logic circuit adapted to control application of the inrush current at the beginning of each on/off cycle and the application of the holding current at the end of the inrush cycle time, the logic circuit also having control pin for selecting control based on the presence of voltage at the voltage rectifying circuit or a separate activation signal.
